(19) United States
(12) Patent Application Publication
(10) Pub. No.: US 2010/0195464 A1
(43) Pub. Date: Aug. 5, 2010

(54) INTEGRATED CIRCUIT, OPTICAL DISC SYSTEM AND TRACKING ERROR SIGNAL GENERATION METHOD

(75) Inventors: Tsuyoshi Katayama, Kyoto (JP); Takeharu Yamamoto, Osaka (JP); Mitsuru Sakai, Osaka (JP)

Correspondence Address: MCDERMOTT WILL & EMERY LLP, 600 13TH STREET, NW, WASHINGTON, DC, 20005-3096, US

(73) Assignee: PANASONIC CORPORATION, Osaka (JP)

(21) Appl. No.: 12/666,998

(22) PCT Filed: Jul. 2, 2008
(86) PCT No.: PCT/JP2008/001735

§ 371 Date: Dec. 28, 2009

(30) Foreign Application Priority Data
Jul. 2, 2007 (JP) 2007-173673

(51) Int. Cl. G11B 20/10

(52) U.S. Cl. 369/59.1

(57) ABSTRACT

A first comparator (112a) compares a first voltage signal to a predetermined threshold to output a first binary signal corresponding to a comparison result. A second comparator (112b) compares a second voltage signal to a predetermined threshold to output a second binary signal corresponding to a comparison result. A first digital sampling section (113a) samples the first binary signal output by the first comparator 112a to generate a first sampling signal. A second digital sampling section (113b) samples the second binary signal output by the second comparator (112b) to generate a second sampling signal. A phase difference detector circuit (114) detects a phase difference between the first sampling signal generated by the first digital sampling section (113a) and the second sampling signal generated by the second digital sampling section (113b).

### TECHNICAL FIELD

The present disclosure relates to a technique for generating a tracking error signal in an optical disc system.

### BACKGROUND ART

Conventionally, it has been difficult to develop tracking error detectors for generating a tracking error signal by analog signal processing, which are compatible with double-speed optical disc systems and optical recording media with increased density.

In order to cope with the difficulty, a tracking error detector disclosed in Patent Document 1 is configured to generate a tracking error signal mainly by digital signal processing. Specifically, in the tracking error detector of Patent Document 1, AD conversion is performed to a first voltage signal indicating an amount of light received at two light acceptance surfaces of a four-quadrant photodetector, and a second voltage signal indicating an amount of light received at the other two light acceptance surfaces of the four-quadrant photodetector by ADC (analog-to-digital converter), thereby obtaining first and second digital signals indicating respective amplitude values of the first and second voltage signals in terms of multiple bits (see FIG. 2 of Patent Document 1). Then, the first and second digital signals are interpolated, zero-cross points of the first and second digital signals after the interpolation is performed are detected, and thus, a tracking error signal is generated based on the zero-cross points of the first digital signal and the zero-cross points of the second

### CITATION LIST

### PATENT DOCUMENT

PATENT DOCUMENT 1: Japanese Patent Publication No. 2001-67690

### SUMMARY OF THE INVENTION

### Technical Problem

However, in the tracking error detector of Patent Document 1, a plurality of ADCs for converting an analog signal to a multiple bit digital signal are provided, and thus, a circuit size is increased, resulting in increase in costs.

In view of the above-described points, the present invention has been devised to reduce costs of a tracking error detector.

### Solution to the Problem

To solve the above-described problems, the present invention is directed to tracking error signal generation processing in an optical disc system including a divided photodetector having first and second light acceptance surfaces for receiving, when an optical recording medium is irradiated with light, reflection light from the optical recording medium, for generating a tracking error signal based on a first voltage signal indicating an amount of light received at the first light acceptance surface and a second voltage signal indicating an amount of light received at the second light acceptance surface, and the tracking error signal generation processing according to the present invention is characterized by including: a first comparison processing of comparing the first voltage signal to a predetermined threshold to generate a first binary signal corresponding to a comparison result; a second comparison processing of comparing the second voltage signal to a predetermined threshold to generate a second binary signal corresponding to a comparison result; a first digital sampling processing of sampling the first binary signal generated by the first comparison processing at a predetermined sampling frequency to generate a first sampling signal; a second digital sampling processing of sampling the second binary signal generated by the second comparison processing at a predetermined sampling frequency to generate a second sampling signal; a phase difference detection processing of detecting a phase difference between the first sampling signal generated in the first digital sampling processing and the second sampling signal generated in the second digital sampling processing to generate a phase difference signal indicating a detected phase difference; and high frequency components cutting off processing of cutting off high frequency components of the phase difference signal generated in the phase difference detection processing to output a resultant signal as the tracking error signal.

Thus, the first voltage signal and the second voltage signal can be converted respectively to the first sampling signal and the second sampling signal which are digital signals to generate a tracking error signal based on the first sampling signal and the second sampling signal. Therefore, there is no need to use an ADC for converting an analog signal to a multiple bit digital signal, so that an area of an analog circuit can be reduced. As a result, the size of the entire circuit can be reduced, thus resulting in reduction in costs.

### ADVANTAGES OF THE INVENTION

According to the present invention, there is no need to use an ADC for converting an analog signal to a multiple bit digital signal, so that an area of an analog circuit can be reduced. As a result, a circuit size of a tracking error detector can be reduced, thus resulting in reduction in costs.

### BRIEF DESCRIPTION OF THE DRAWINGS

FIG. 1 is a block diagram illustrating a configuration of a tracking error detector according to a first embodiment.

FIG. 2 is a block diagram illustrating a configuration of a tracking error detector according to a second embodiment.

FIG. 3 is a block diagram illustrating a configuration of a tracking error detector according to a third embodiment.

FIG. 4 is a block diagram illustrating a configuration of a tracking error detector according to a fourth embodiment.

FIG. 5 is a graph showing group delay characteristics of an equalizer according to the fourth embodiment.

DESCRIPTION OF REFERENCE CHARACTERS

| | |
|---|---|
| 101 | Four-quadrant photodetector |
| | (divided photodirector) |
| 101a-101d | Light acceptance surfaces |
| 110 | Integrated circuit |
| 112a | First comparator |
| 112b | Second comparator |
| 113a | First digital sampling section |
| 113b | Second digital sampling section |
| 114 | Phase difference detector circuit |
| 115 | Low-pass filter |
| 116 | Averaging circuit |
| 210 | Integrated circuit |
| 211 | Sampling frequency setting section |
| 212 | Low-pass filter control section |
| 310 | Integrated circuit |
| 311a | First delay circuit |
| 311b | Second delay circuit |
| 312 | Delay amount control section |
| 410 | Integrated circuit |
| 411a | First equalizer |
| 411b | Second equalizer |

### DESCRIPTION OF EMBODIMENTS

Embodiments of the present invention will be hereinafter described with reference to the accompanying drawings.

### First Embodiment

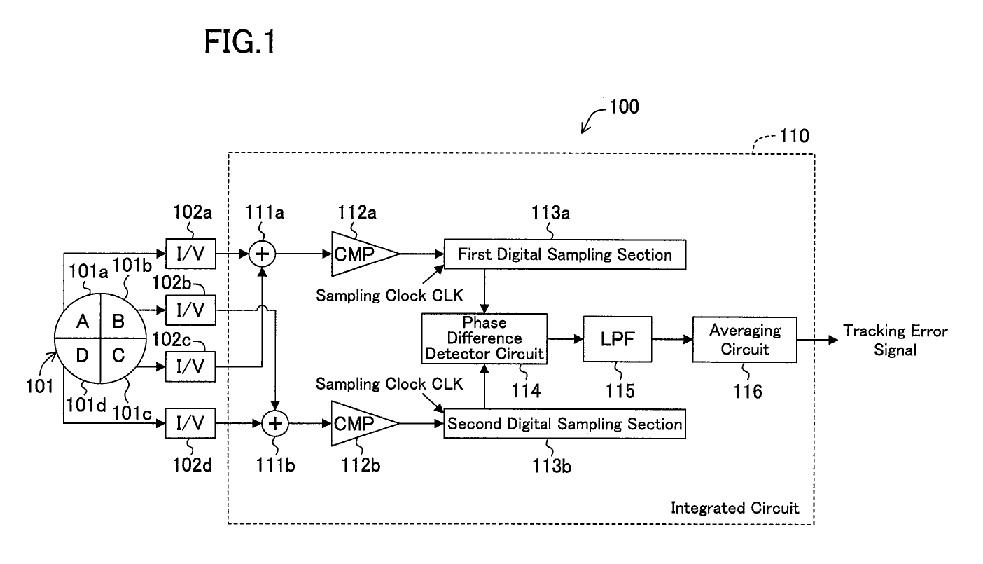

An optical disc system according to a first embodiment includes a tracking error detector 100 shown in FIG. 1. The tracking error detector 100 includes a four-quadrant photodetector 101, four current-voltage converters 102a through 102d, and an integrated circuit 110.

The four-quadrant photodetector 101 includes four light acceptance surfaces 101a through 101d as A channel, B channel, C channel and D channel, and outputs a photocurrent corresponding to an amount of light received at each of the light acceptance surfaces 101a through 101d. In this case, the light acceptance surfaces 101a and 101c correspond to a first light acceptance surface in the scope of claims, and the light acceptance surfaces 101b and 101d correspond to a second light acceptance surface in the scope of claims.

The current-voltage converter 102a converts a photocurrent corresponding to an amount of light received at the light acceptance surface 101a to a voltage signal to output the voltage signal. Similarly, the current-voltage converter 102b converts a photocurrent corresponding to an amount of light received at the light acceptance surface 101b to a voltage signal to output the voltage signal, the current-voltage converter 102c converts a photocurrent corresponding to an amount of light received at the light acceptance surface 101c to a voltage signal to output the voltage signal, and the current-voltage converter 102d converts a photocurrent corresponding to an amount of light received at the light acceptance surface 101d to a voltage signal to output the voltage signal.

The integrated circuit 110 includes adders 111a and 111b, a first comparator (CMP) 112a, a second comparator (CMP) 112b, a first digital sampling section 113a, a second digital sampling section 113b, a phase difference detector circuit 114, a low-pass filter (LPF) 115, and an averaging circuit 116.

The adder 111a adds a voltage signal output by the current-voltage converter 102a and a voltage signal output by the current-voltage converter 102c to output a first voltage signal. The adder 111b adds a voltage signal output by the current-voltage converter 102b and a voltage signal output by the current-voltage converter 102d to output a second voltage signal. The first voltage signal and the second voltage signal are two signal series between which a phase varies. Moreover, each of the first voltage signal and the second voltage signal corresponds an amount of light returning to a pair of light acceptance surfaces diagonally disposed in the photodetector.

The first comparator 112a compares the first voltage signal output by the adder 111a to a predetermined threshold and generates a first binary signal corresponding to a comparison result to output the first binary signal. For example, the first comparator 112a outputs, as the first binary signal, a signal which is H (High) level when the first voltage signal is higher than the predetermined threshold and is L (Low) level when the first voltage signal is equal to or lower than the predetermined threshold.

The second comparator 112b compares the second voltage signal output by the adder 111b to a predetermined threshold and generates a second binary signal corresponding to a comparison result to output the second binary signal. For example, the second comparator 112b outputs, as the second binary signal, a signal which is H level when the second voltage signal is higher than the predetermined threshold and is L level when the second voltage signal is equal to or lower than the predetermined threshold.

The first digital sampling section 113a samples the first binary signal output by the first comparator 112a at a predetermined sampling frequency to generate a first sampling signal.

The second digital sampling section 113b samples the second binary signal output by the second comparator 112b at a predetermined sampling frequency to generate a second sampling signal.

Note that the sampling frequency of the first digital sampling section 113a and the sampling frequency of the second digital sampling section 113b are set at the same value.

The phase difference detector circuit 114 detects a phase difference between the first sampling signal generated by the first digital sampling section 113a and the second sampling signal generated by the second digital sampling section 113b to generate a phase difference signal indicating the phase difference. Specifically, the phase difference detector circuit 114 generates a phase difference signal with pulses having a pulse width corresponding to a time lag between respective changes of the first sampling signal and the second sampling signal. For example, as shown in FIG. 8 of Japanese Patent Publication No. 2001-67690 and the like, a first signal which is H level during a period of time in which the first sampling signal is H level and which starts at a trailing edge of the second sampling signal and lasts until a next trailing edge of the first sampling signal, and is L level in other periods of time, and a second signal which is H level during a period of time in which the second sampling signal is at H level and which starts at a trailing edge of the first sampling signal and lasts until a next trailing edge of the second sampling signal, and is L level in other periods of time are generated, and a signal obtained by subtracting the second signal from the first signal is used as a phase difference signal.

The low-pass filter 115 band-limits the phase difference signal generated by the phase difference detector circuit 114, i.e., the low-pass filter 115 cuts off high frequency components to output a resultant signal as a tracking error signal.

The averaging circuit 116 averages the tracking error signal output by the low-pass filter 115. Specifically, the averaging circuit 116 calculates, in each period corresponding to multiple sampling cycles of the first digital sampling section 113a and the second digital sampling section 113b, a mean value of the tracking error signal for the period, replaces the tracking error signal for the period with the mean value which is a calculation result, and outputs the mean value.

The optical disc system of this embodiment includes an optical pick-up for irradiating an optical recording medium with light, and performs tracking control based on the tracking error signal output by the averaging circuit 116. This tracking control is a control to drive a lens in the optical pick-up so that the tracking error is reduced.

In the optical disc system configured in the above-described manner, when an optical recording medium is irradiated with light, the light acceptance surfaces 101a through 101d of the four-quadrant photodetector 101 receive reflection light from the optical recording medium. Then, a photocurrent corresponding to an amount of light received at each of the light acceptance surfaces 101a through 101d is output from the four-quadrant photodetector 101. The current-voltage converter 102a converts the photocurrent corresponding to the amount of light received at the light acceptance surface 101a to a voltage signal to output the voltage signal, the current-voltage converter 102b converts the photocurrent corresponding to the amount of light received at the light acceptance surface 101b to a voltage signal to output the voltage signal, the current-voltage converter 102c converts the photocurrent corresponding to the amount of light received at the light acceptance surface 101c to a voltage signal to output the voltage signal, and the current-voltage converter 102d converts the photocurrent corresponding to the amount of light received at the light acceptance surface 101d to a voltage signal to output the voltage signal. In this case, assume that a level of the voltage signal output by the current-voltage converter 102a is A, a level of the voltage signal output by the current-voltage converter 102b is B, a level of the voltage signal output by the current-voltage converter 102c is C, and a level of the voltage signal output by the current-voltage converter 102d is D. The voltage signal output by the current-voltage converter 102a and the voltage signal output by the current-voltage converter 102c are added by the adder 111a, and then, a first voltage signal of the (A+C) level is output as a sum signal from the adder 111a. The voltage signal output by the current-voltage converter 102b and the output signal output by the current-voltage converter 102d are added by the adder 111b, and then, a second voltage signal of the (B+D) level is output as a sum signal from the adder 111b.

When an optical spot is located at a center of a pit in the cross direction, the first voltage signal and the second voltage signal have the same phase. On the other hand, when an optical spot is located at a point shifted from the center of a pit in the cross direction, an error is generated in the phases of the first voltage signal and the second voltage signal. A method for generating a tracking error signal corresponding to the amount of a phase difference, based on the first voltage signal and the second voltage signal will be hereinafter described.

A first voltage signal output by the adder 111a is converted to a first binary signal by the first comparator 112a. The first digital sampling section 113a samples the first binary signal to output a first sampling signal. Similarly, a second voltage signal output by the adder 111b is converted to a second binary signal by the second comparator 112b. The second digital sampling section 113b samples the second binary signal to output a second sampling signal. Then, the phase difference detector circuit 114 generates a phase difference signal based on the first sampling signal and the second sampling signal. The phase difference signal undergoes cutting-off of high frequency components by the low-pass filter 115 and averaging by the averaging circuit 116, and then, is used as a tracking error signal in tracking control. The frequency of an input RF signal, i.e., the frequency of each of the first voltage signal and the second voltage signal is normally higher than a frequency corresponding to a cycle of servo control, and thus, averaging by the averaging circuit 116 is possible.

According to this embodiment, the low-pass filter 115 limits a band of a phase difference signal generated by the phase difference detector circuit 114 to a necessary frequency band for a tracking error signal, so that influences of noise on the tracking error signal can be reduced.

Moreover, the averaging circuit 116 performs averaging to a tracking error signal output by the low-pass filter 115. Thus, when the first binary signal and the second signal at a time point where large influences of noise largely appear are sampled by the first digital sampling section 113a and the second digital sampling section 113b, the influences of noise can be reduced. As a result, a highly accurate tracking error signal can be obtained by digital signal processing and can be used in tracking control.

Note that as the sampling frequency of each of the first digital sampling section 113a and the second digital sampling section 113b, i.e., the frequency of a sampling clock for operating the first digital sampling section 113a and the second digital sampling section 113b becomes higher, an amount of a phase error of each of the first voltage signal and the second voltage signal can be detected with a higher degree of accuracy, and thus, a highly accurate tracking error signal can be generated. Also, the sampling frequency may be set to be variable so that optimal sampling can be performed according to the frequency of the first voltage signal and the second voltage signal, and a state of the optical disc system.

The order of connection of the low-pass filter 115 and the averaging circuit 116 may be reversed. That is, the low-pass filter 115 and the averaging circuit 116 may be configured so that a phase difference signal generated by the phase difference detector circuit 114 is input to the averaging circuit 116, and an output of the averaging circuit 116 is input to the low-pass filter 115. Even with this configuration, the above-described effect of reducing noise can be achieved.

In light of the characteristics of low-pass filters, it is apparent that noise reducing and averaging can be performed using the low-pass filter 115.

### Second Embodiment

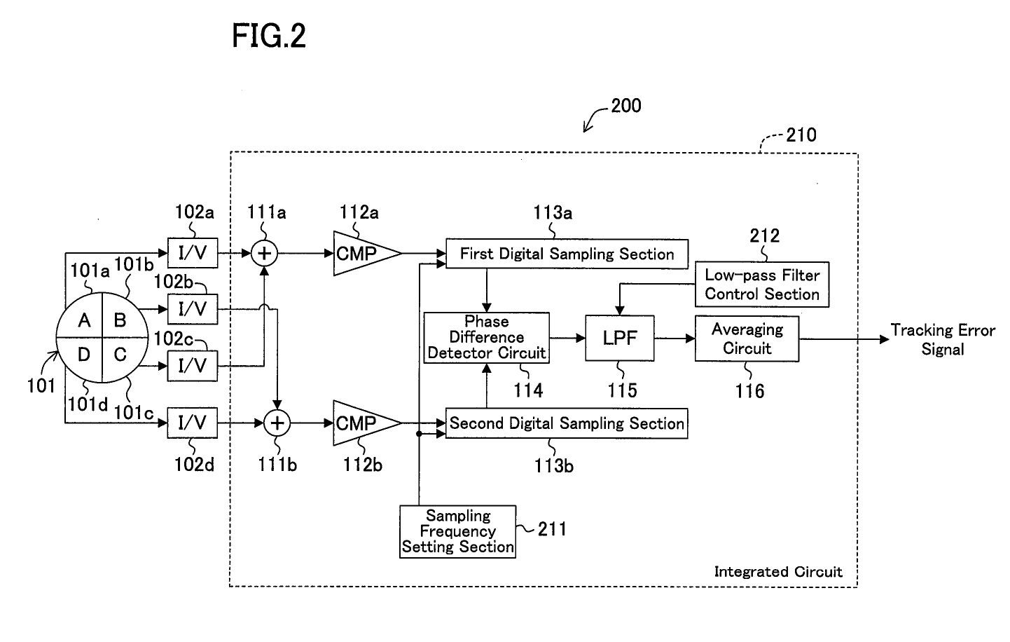

An optical disc system according to a second embodiment of the present invention includes, instead of the tracking error detector 100 of the first embodiment, a tracking error detector 200 shown in FIG. 2. The tracking error detector 200 includes, instead of the integrated circuit 110 of the tracking error detector 100, an integrated circuit 210. The integrated circuit 210 includes, in addition to the components of the integrated circuit 110 of the first embodiment, a sampling frequency setting section 211 and a low-pass filter control section 212. The configuration and operation of other components of the optical disc system of this embodiment are the same as those of the first embodiment, and therefore, the detail description thereof will be omitted.

The sampling frequency setting section 211 sets each of sampling frequencies of the first digital sampling section 113a and the second digital sampling section 113b to be a different frequency from an integral multiple of a frequency of a RF signal, i.e. a different frequency from an integral multiple of the frequency of the first voltage signal and the second voltage signal. In this embodiment, the sampling frequency of each of the first digital sampling section 113a and the second digital sampling section 113b, i.e., the frequency of a sampling clock is variable, and is set according to the frequency of the first voltage signal and the second voltage signal, the degree of accuracy of a tracking error signal required in the system, a state of the optical disc system, and the like.

The low-pass filter control section (coefficient control section) 212 sets a cut-off frequency of the low-pass filter 115 so that a constant frequency characteristic of the low-pass filter 115 is maintained. That is, the cut-off frequency of the low-pass filter 115 is variable, and is varied when the frequency of the sampling clock for the first digital sampling section 113a and the second digital sampling section 113b is changed.

According to this embodiment, the same effects as those of the first embodiment can be achieved, and also, the sampling frequency is set so that it varies according to conditions such as the frequency of the first voltage signal and the second voltage signal, the degree of accuracy of a tracking error signal required in the system, a state of the optical disc system, and the like. Thus, proper sampling according to such conditions can be performed. Therefore, a highly accurate tracking error signal can be generated.

For example, when the sampling clock of the first digital sampling section 113a and the second digital sampling section 113b is synchronized with input RF signals, i.e., the first voltage signal and the second voltage signal, the phase difference detector circuit 114 might not be able to correctly detect an amount of the phase difference. According to this embodiment, the sampling frequency setting section 211 sets the sampling frequency of each of the first digital sampling section 113a and the second digital sampling section 113b to be a different frequency from an integral multiple of the frequency of the first voltage signal and the second voltage signal. Thus, the sampling clock of the first digital sampling section 113a and the second digital sampling section 113b can be prevented from being synchronized with the input RF signals. As a result, a phase difference can be more correctly detected, and a highly accurate tracking error signal can be generated. Furthermore, the linearity of a tracking error signal obtained by phase difference detection can be maintained, and also, the degradation of frequency characteristics which tends to be caused when the phase difference is close to zero can be prevented.

### Third Embodiment

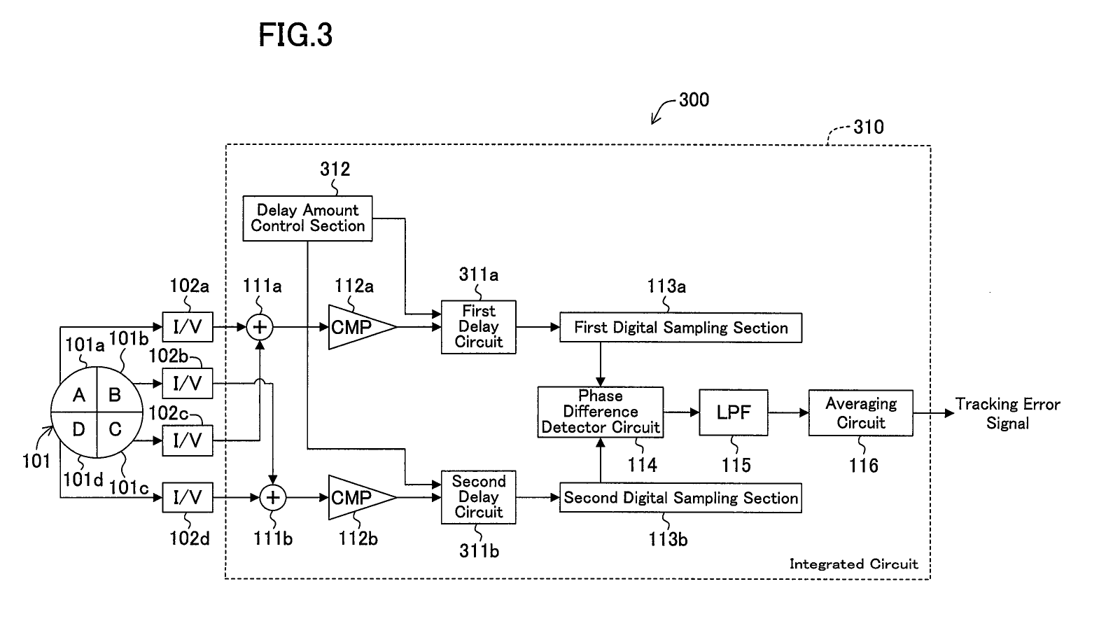

An optical disc system according to a third embodiment of the present invention includes, instead of the tracking error detector 100 of the first embodiment, a tracking error detector 300 shown in FIG. 3. The tracking error detector 300 includes, instead of the integrated circuit 110 of the tracking error detector 100, an integrated circuit 310. The integrated circuit 310 includes, in addition to the components of the integrated circuit 110 of the first embodiment, a first delay circuit 311a, a second delay circuit 311b, and a delay amount control section (controller) 312. The configuration and operation of other components of the optical disc system of this embodiment are the same as those of the first embodiment, and therefore, the detail description thereof will be omitted.

The first delay circuit 311a delays a first binary signal output by the first comparator 112a before the first binary signal is input to the first digital sampling section 113a.

The second delay circuit 311b delays a second binary signal output by the second comparator 112b before the second binary signal is input to the second digital sampling section 113b.

The delay amount control section 312 sets a delay amount of each of the first delay circuit 311a and the second delay circuit 311b so that the first binary signal is not synchronized with the sampling timing of the first digital sampling section 113a and the second binary signal is not synchronized with the sampling timing of the second digital sampling section 113b. Note that respective delay amounts of the first delay circuit 311a and the second delay circuit 311b are set to be the same value. The delay amount control section 312 is preferably configured to be able to set a delay amount to be equal to or larger than the sampling clock cycle of the first digital sampling section 113a and the second digital sampling section 113b.

According to this embodiment, the same effects as those of the first embodiment can be achieved, and also, the delay amount can be changed at all the time, for example, in a frequency band ranging from a higher frequency than a frequency corresponding to a cycle of servo control to a lower frequency than a frequency of a RF signal. That is, the delay amount can be changed in a cycle which is shorter than the cycle of servo control and is longer than the frequency of a RF signal.

In this embodiment, the delay amount control section 312 sets the delay amount of each of the first delay circuit 311a and the second delay circuit 311b so that the first binary signal is not synchronized with the sampling timing of the first digital sampling section 113a and the second binary signal is not synchronized with the sampling timing of the second digital sampling section 113b. Thus, the sampling clock of each of the first digital sampling section 113a and the second digital sampling section 113b can be prevented from being synchronized with the input RF signals. As a result, a phase difference can be more correctly detected, and a highly accurate tracking error signal can be generated. Furthermore, the linearity of a tracking error signal obtained by phase difference detection can be maintained, and also, the degradation of frequency characteristics which tends to be caused when the phase difference is close to 0 can be prevented.

Moreover, by setting the respective delay amounts of the first delay circuit 311a and the second delay circuit 311b to be the same value, and then performing simultaneous control thereto, the sampling clock of each of the first digital sampling section 113a and the second digital sampling section 113b can be prevented from being synchronized with the input RF signals without affecting a proper value of a tracking error signal.

### Fourth Embodiment

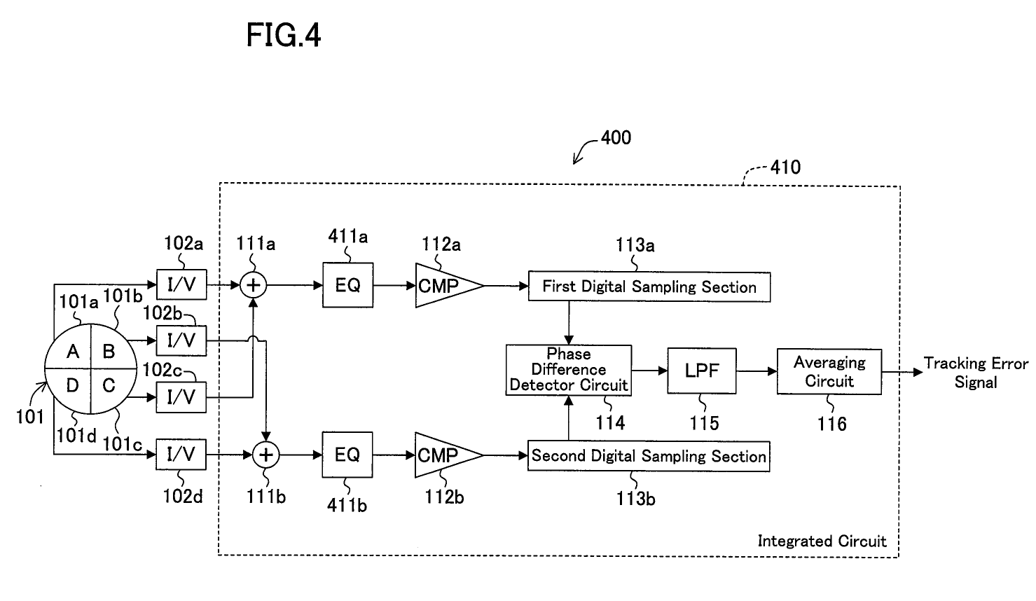

An optical disc system of a fourth embodiment of the present invention includes, instead of the tracking error detector 100 of the first embodiment, a tracking error detector 400 shown in FIG. 4. The tracking error detector 400 includes, instead of the integrated circuit 110 of the tracking error detector 100, an integrated circuit 410. The integrated circuit 410 includes, in addition to the components of the integrated circuit 110 of the first embodiment, a first equalizer (EQ) 411a and a second equalizer (EQ) 411b. The configuration and operation of other components of the optical disc system of this embodiment are the same as those of the first embodiment, and therefore, the detail description thereof will be omitted.

The first equalizer (filter) 411a generates a group delay on a first voltage signal output by the adder 111a. That is, the first equalizer 411a delays each of frequency components constituting the first voltage signal for a delay amount corresponding to a frequency of the component before the first voltage signal is input to the first comparator 112a.

The second equalizer (filter) 411b generates a group delay on a second voltage signal output by the adder 111b. That is, the second equalizer 411b delays each of frequency components constituting the second voltage signal for a delay amount corresponding to a frequency of the component before the second voltage signal is input to the second comparator 112b.

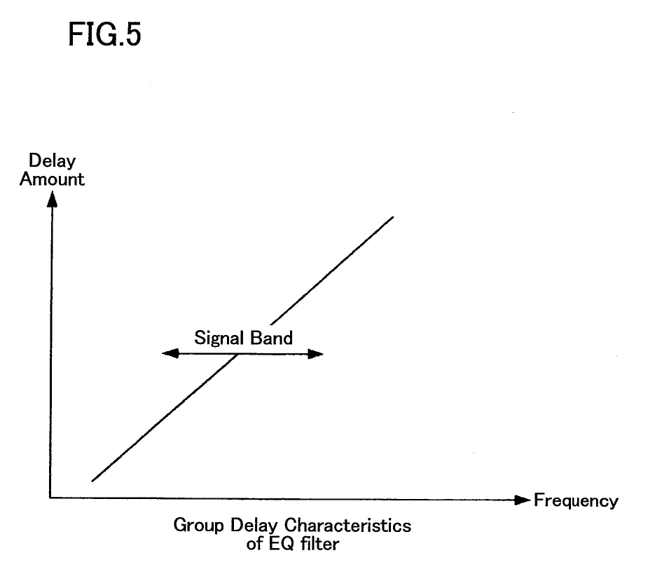

FIG. 5 shows group delay characteristics of the first equalizer 411a and the second equalizer 411b. Each of the first equalizer 411a and the second equalizer 411b causes a delay so that the amount of delay to a frequency component in a higher frequency band is larger. In this case, a frequency at which a delay is caused, i.e., a signal band, and a delay amount corresponding to each frequency may be fixed or variable. The delay amounts of the first equalizer 411a and the second equalizer 411b, i.e., the delay amounts of the first voltage signal and the second voltage signal are set to be the same value.

According to this embodiment, for example, the first voltage signal and the second voltage signal can be delayed for a delay amount corresponding to an inversion interval of modulated data read out from an optical recording medium by the first equalizer 411a and the second equalizer 411b. When the optical recording device is a DVD, the inversion interval of modulated data is set to be one of 3 T through 11 T and 14 T (T is a clock cycle). In this case, for example, the delay amount can be set to be larger when modulated data whose inversion interval is 3 T is read out than when modulated data whose inversion interval is 11 T is read out. As described above, the first voltage signal and the second voltage signal are delayed for a delay amount corresponding to an inversion interval of modulated data, and thereby, the first voltage signal and the second voltage signal are input to the first comparator 112a and the second comparator 112b, respectively, in a state where a jitter is added due to intersymbol interference in the time axis direction. Thus, synchronization of the sampling clock with the input RF signal can be prevented by setting the delay amount of each of the first equalizer 411a and the second equalizer 411b so that the sampling clocks of the first digital sampling section 113a and the second digital sampling section 113b is not synchronized with the first voltage signal and the second voltage signal (input RF signals), respectively. As a result, a phase difference can be more correctly detected, and a highly accurate tracking error signal can be generated. Furthermore, the linearity of a tracking error signal obtained by phase difference detection can be maintained, and also, the degradation of frequency characteristics which tends to be caused when the phase difference is close to 0 can be prevented.

Moreover, by setting the respective delay amounts of the first voltage signal and the second voltage signal to be the same value, and then performing simultaneous control thereto, i.e., by causing delay amounts corresponding to all input channels to be all the same, the sampling clock of each of the first digital sampling section 113a and the second digital sampling section 113b can be prevented from being synchronized with the input RF signals without affecting a proper value of a tracking error signal.

The case where the optical recording medium is a DVD has been described above. However, this embodiment is applicable to the case where the optical recording medium is some other medium than a DVD. For example, this embodiment can be applied to generate a highly accurate tracking error signal when the optical recording medium is a next generation disc employing blue laser. When the optical recording medium is a Blu-ray Disc (registered trademark), the inversion interval of modulated data is set to be one of 2 T through 8 T and 9 T (T is a clock cycle).

In each of the above-described first through fourth embodiments, the four-quadrant photodetector 101 including the four light acceptance surfaces 101a through 101d is used. However, such a four-quadrant photodetector including the four light acceptance surfaces does not necessarily have to be used, but a divided photodetector including at least two light acceptance surfaces may be used.

In each of the above-described first through fourth embodiments, the averaging circuit 116 does not necessarily have to be provided. That is, a tracking error signal output by the low-pass filter 115 may be used in tracking control without being averaged.

### INDUSTRIAL APPLICABILITY

An integrated circuit, an optical disc system and a tracking error signal generation method according to the present invention have the effect of reducing a circuit size of a tracking error detector and also reducing costs, and thus are useful as a technique for generating a tracking error signal in the optical disc system.

1. An integrated circuit, provided in an optical disc system including a divided photodetector having first and second light acceptance surfaces for receiving, when an optical recording medium is irradiated with light, reflection light from the optical recording medium, for generating a tracking error signal based on a first voltage signal indicating an amount of light received at the first light acceptance surface and a second voltage signal indicating an amount of light received at the second light acceptance surface, the integrated circuit comprising:
a first comparator for comparing the first voltage signal to a predetermined threshold to output a first binary signal corresponding to a comparison result;
a second comparator for comparing the second voltage signal to a predetermined threshold to output a second binary signal corresponding to a comparison result;
a first digital sampling section for sampling the first binary signal output by the first comparator at a predetermined sampling frequency to generate a first sampling signal;
a second digital sampling section for sampling the second binary signal output by the second comparator at a predetermined sampling frequency to generate a second sampling signal;
a phase difference detector circuit for detecting a phase difference between the first sampling signal generated by the first digital sampling section and the second sampling signal generated by the second digital sampling section to generate a phase difference signal indicating a detected phase difference; and
a low-pass filter for cutting off high frequency components of the phase difference signal generated by the phase difference detector circuit to output a resultant signal as the tracking error signal.

2. The integrated circuit of claim 1, further comprising:
an averaging circuit for calculating, in each period corresponding to multiple sampling cycles of the first digital sampling section and the second digital sampling section, a mean value of the tracking error signal output by the low-pass filter for the period, and replacing the tracking error signals with a mean value as a calculation result.

3. The integrated circuit of claim 1, further comprising:
a sampling frequency setting section for setting a sampling frequency of each of the first digital sampling section and the second digital sampling section to be a different frequency from an integral multiple of a frequency of the first voltage signal and the second voltage signal; and
a low-pass filter control section for setting a cut-off frequency of the low-pass filter so that a constant frequency characteristic of the low-pass filter is maintained.

4. The integrated circuit of claim 1, further comprising:
a first delay circuit for delaying the first binary signal output by the first comparator before the first binary signal is input to the first digital sampling section;
a second delay circuit for delaying the second binary signal output by the second comparator before the second binary signal is input to the second digital sampling section; and
a delay amount control section for setting respective delay amounts of the first delay circuit and the second delay circuit so that the first binary signal is not synchronized with a sampling timing of the first digital sampling section and the second binary signal is not synchronized with a sampling timing of the second digital sampling section.

5. The integrated circuit of claim 1, further comprising:
a first equalizer for delaying each of frequency components constituting the first voltage signal for a delay amount corresponding to a frequency of the frequency component before the first voltage signal is input to the first comparator; and
a second equalizer for delaying each of frequency components constituting the second voltage signal for a delay amount corresponding to a frequency of the frequency component before the second voltage signal is input to the second comparator.

6. An optical disc system comprising:
the integrated circuit of claim 1; and
the divided photodetector,
wherein
tracking control is performed based on a tracking error signal output by the low-pass filter.

7. A method for generating, in an optical disc system including a divided photodetector having first and second light acceptance surfaces for receiving, when an optical recording medium is irradiated with light, reflection light from the optical recording medium, a tracking error signal based on a first voltage signal indicating an amount of light received at the first light acceptance surface and a second voltage signal indicating an amount of light received at the second light acceptance surface, the method comprising:
a first comparison step of comparing the first voltage signal to a predetermined threshold to output a first binary signal corresponding to a comparison result;
a second comparison step of comparing the second voltage signal to a predetermined threshold to output a second binary signal corresponding to a comparison result;
a first digital sampling step of sampling the first binary signal output by the first comparison step at a predetermined sampling frequency to generate a first sampling signal;
a second digital sampling step of sampling the second binary signal output by the second comparison step at a predetermined sampling frequency to generate a second sampling signal;
a phase difference detecting step of detecting a phase difference between the first sampling signal generated by the first digital sampling step and the second sampling signal generated by the second digital sampling step to generate a phase difference signal indicating a detected phase difference; and
a low-pass filter cutting off step of cut-offing high frequency components of the phase difference signal generated by the phase difference detecting step to output a resultant signal as the tracking error signal.
